(19) United States
(12) Patent Application Publication
(10) Pub. No.: US 2006/0187780 A1
(43) Pub. Date: Aug. 24, 2006

(54) INFORMATION RECORDING APPARATUS CAPABLE OF MANAGING RECORDING COUNT

(75) Inventor: Eishi Takeda, Ohta-Ku (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Ohta-Ku (JP)

(21) Appl. No.: 11/276,230

(22) Filed: Feb. 20, 2006

(30) Foreign Application Priority Data
Feb. 24, 2005 (JP) 2005-048994

(51) Int. Cl. G11B 5/09

(52) U.S. Cl. 369/47.1; 369/53.2

(57) ABSTRACT

In an information recording medium, there is a tendency that unevenness in the number of times of access is liable to be generated between an area frequently accessed and an area not frequently accessed, so that a fault such as a write error, a read error, or the like is liable to occur due to physical degradation with time or the like resulting from frequent access to a specific area. Therefore, the numbers of times of recording of respective areas are managed to avoid nonuniformity of the numbers of times.

### BACKGROUND OF THE INVENTION

1. Field of the Invention

The present invention relates to an information recording apparatus for recording an information on a randomly accessible information recording medium such as an optical disk or the like.

2. Related Background

Hitherto, when an information is recorded on an information recording medium, the recording/writing on a disk is performed with reference to a free area management table. FIG. 13 shows the structure of a free area management table. The free area management table manages recording area of an information recording medium in block units such as sectors or the like. The block unit is a minimum access unit in which data is read from or written to a disk-shaped recording medium, and the table has a bitmap for determining whether data is already recorded in the respective block or not with a bit information of 0 and 1 corresponding to all blocks on the disk.

FIG. 14 schematically shows a recording area immediately after a plurality of data files have been actually recorded to a disk based on a free area management table. When writing/recording of data is further performed on the disk, unrecorded areas (S301 and S302) in which the bits of 0 are continuously detected are searched from the inner periphery side of the disk. Then, data is written in a free area from the inner periphery side of S301 in the procedure shown in FIGS. 15 and 16, and the corresponding recording area in the free area management table is updated as recorded (bit of 1).

Further, when a user deletes data later from the thus data-recorded disk, the area corresponding to a data-deleted area DEL601 in the free area management table is updated as unrecorded (bit of 0) as shown in FIG. 17.

Afterwards, when data is newly recorded (written) on the disk, the data is written in an overwriting fashion to the area DEL601 whose data has been deleted by the above-mentioned procedure, and then recording is carried out to an area S602 as a recordable area after jumping as shown in FIG. 18. Such conventional technology is disclosed by, for example, Japanese Patent Application Laid-Open No. H05-67005.

In the conventional technology, there has been caused a situation that access to a disk by deletion and recording/writing operations concentrates on a specific area thereof. Therefore, unevenness in the number of times of access will be generated between an area of the disk frequently accessed and an area thereof not frequently accessed, so that a fault such as a write error, a read error, or the like is liable to occur due to physical degradation with time or the like resulting from frequent access to the specific area.

### SUMMARY OF THE INVENTION

It is, therefore, an object of the present invention to provide an information recording apparatus that can reduce or prevent the fault due to the concentration of access on a specific area of a recording medium.

According to the present invention, there is provided an information recording apparatus in which a recording area of an information recording medium is managed in block units of a predetermined size, comprising:
a memory for storing an information to numbers of times of recording of respective blocks and an information to a free area of the respective blocks; and
a circuit for determining a block for recording an information therein based on the both informations stored in the memory.

### BRIEF DESCRIPTION OF THE DRAWINGS

FIG. 1 is a block diagram showing an embodiment of the information recording apparatus according to the present invention;

FIG. 2 is a view showing an example of a number-of-times-of-recording management table used in the embodiment shown in FIG. 1;

FIG. 3 is a view showing an example of data on tables and a disk when a number-of-times-of-recording management table and a free area management table are used;

FIG. 4 is a view showing data of the tables and disk when data has been recorded in a recordable area in the state of the disk shown in FIG. 3;

FIG. 5 is a view showing data of the tables and disk when further recording has been performed in the state shown in FIG. 4;

FIG. 6 is a view showing data structure on the tables and disk when a recordable area is reacquired after the data-writing operation shown in FIG. 5;

FIG. 7 is a view showing data on the tables and disk when a data deletion instruction is issued in a situation in which the whole of recordable areas have not been used;

FIG. 8 is a view showing a state after completion of writing to remaining areas and updating of respective management tables;

FIG. 9 is a view showing a state wherein a data area corresponding to a deletion area becomes obtainable as a recordable area;

FIG. 10 is a view showing data on the two tables and disk when the recording area of the disk reaches the maximum recordable count;

FIG. 11 is a view showing data on the two tables and disk of the apparatus according to the present invention when the disk has been subjected to data writing in an apparatus having no number-of-times-of-recording management table and then inserted in the present apparatus;

FIG. 12 is a view showing data on the two tables and disk when updated in the apparatus according to the present invention in the state shown in FIG. 11;

FIG. 13 is a view showing an example of a free area management table using sectors as access units;

FIG. 14 is a view showing an example of data on the free area management table and a disk when recording is performed on the disk using the free area management table;

FIG. 15 is a view showing data on the table and disk when recording is further performed on the disk using the free area management table in the state shown in FIG. 14;

FIG. 16 is a view showing data on the free area management table and disk when further recording is performed on the disk in the state shown in FIG. 15;

FIG. 17 is a view showing data on the free area management table and disk after data deletion by a user has been performed on the disk subjected to recording as shown in FIG. 16; and

FIG. 18 is a view showing data on the free area management table and disk when data writing is newly performed to the disk after the data deletion shown in FIG. 17.

### DESCRIPTION OF THE PREFERRED EMBODIMENTS

Next, preferred embodiments of the present invention will be described below in detail with reference to the attached drawings.

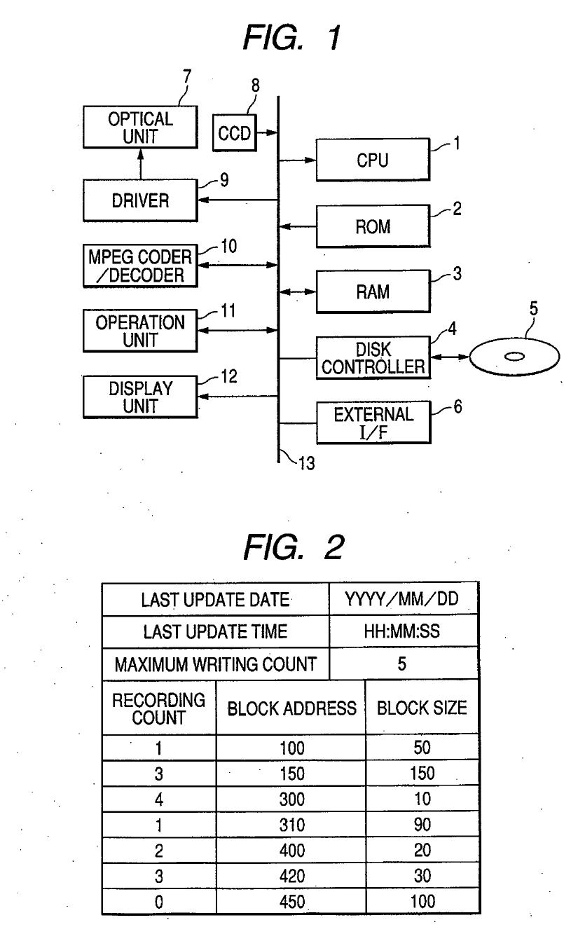

FIG. 1 is a block diagram showing the configuration of an embodiment of the information recording apparatus according to the present invention. In FIG. 1, reference numeral 1 denotes a CPU that controls respective units of the apparatus. The CPU 1 also performs search and update of a number-of-times-of-recording management table (hereinafter, simply referred to as “recording count management table”) and a free area management table which will be described later. Reference numeral 2 denotes a ROM that houses a control program or the like. Reference numeral 3 denotes a RAM that houses various data or the like. The recording count management table and the free area management table are also formed in the RAM 3.

Reference numeral 5 denotes a disk such as an optical disk for recording or reproducing an information and is attachable to and detachable from the body of the apparatus. Reference numeral 4 denotes a disk controller 4 that controls record or reproduction of information to or from a disk 5; reference numeral 6 denotes a connection interface (external I/F) for connection to an external equipment (computer, etc.); reference numeral 7 denotes an optical unit 7 that includes an optical system such as a pick-up, etc; and reference numeral 8 denotes a CCD for image input.

Further, reference numeral 9 denotes a driver that drives and controls the optical unit 7; reference numeral 10 denotes an MPEG coder/decoder that performs coding of recorded data and decoding of reproduced data; reference numeral 11 denotes an operation unit that is used by a user for operation; reference numeral 12 denotes a display unit that displays a menu or the like; and reference numeral 13 denotes a data bus.

FIG. 2 shows an example of the configuration of a recording count management table. In the present embodiment, the access unit of the recording count management table is, for example, the same ECC block unit as the data unit for an error correcting process by ECC, etc. It also may be a sector unit.

Further, the recording count management table has an information to update time of table data, an information indicating how many number of times of data writing (abbreviated as “recording count” in the figure) has been performed, and a block address information and a block size information indicating how many blocks of number of times of recording continue from what address on the disk. Furthermore, a maximum permitted number of times of recording (abbreviated as “maximum recording count” in the figure) that indicates an allowed number of times of writing is set for each block, and when the maximum permitted number of times of recording is reached, the corresponding block is disabled for use as described later. Moreover, in the recording count management table shown in FIG. 2, the block address or the like may be sorted in the order of number of times of recording. Thereby, it becomes possible to perform a searching process at a high speed.

The free area management table is used for managing a free area and a recorded area of the disk 5, and is the same as that in the prior art. That is, as described above, the table has a bitmap corresponding to all sectors of the disk in which indication of a recorded sector is assigned to bit 1 and indication of an unrecorded sector is assigned to bit 0 for the sectors of the disk.

The information for the recording count management table and the free area management table is read from the disk 5 to the RAM 3 under the control of the CPU 1 at the time of power-on, disk insertion or the like of the information recording apparatus. Further, the CPU 1 updates the recording count management table and the free area management table with the timing of completion of recording/writing or deletion process, or the like. The update may also be performed at the time of power-off of the apparatus or disk removal. Furthermore, at the time of power-off or disk removal of the apparatus, the information of the recording count management table and the free area management table is written back to the disk 5.

Incidentally, although in the above description for the free area management table, indication of a recorded sector is assigned to bit information 1 and indication of an unrecorded sector is assigned to bit information 0, inverse assignment may be adopted.

(1) Method of Acquiring Recordable Area

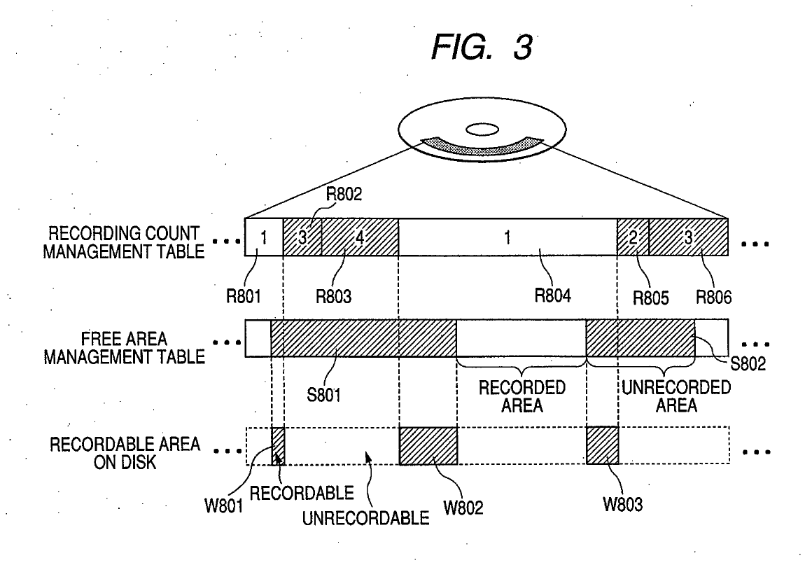

FIG. 3 shows an example of the data structure of recordable areas on a disk using a recording count management table and a free area management table.

As shown in FIG. 3, the recording count management table has an area (R801) having a number of times of recording of 1, an area (R802) having a number of times of recording of 3, an area (R803) having a number of times of recording of 4, an area (R804) having a number of times of recording of 1, an area (R805) having a number of times of recording of 2, an area (R806) having a number of times of recording of 3, . . . from the inner periphery side to the outer periphery side of the disk (the numerical values in the recording count management table each indicate the number of times of recording).

Similarly, it is assumed that the free area management table has two unrecorded areas S801 and S802. To acquire a recordable area on the disk, in the first step, the recording count management table is searched and an information to the position and size of an area of a minimum number of times of recording is acquired. Taking an example of FIG. 3, the areas R801 and R804 having the number of times of recording of 1 correspond thereto.

In the second step, the CPU 1 searches an area which meets both the minimum number of times of recording and the unrecorded areas (S801 and S802) in the free area management table corresponding to the area of the minimum number of times of recording. In the example shown in FIG. 3, the recordable areas (W801, W802, and W803) correspond thereto, and on the basis of this information, recording/writing to the disk will be performed.

In the third step, if no unrecorded sector area can be detected over the entire surface of the disk within the areas having the minimum number of times of recording of 1, then the number of times of recording of the area to be searched is increased by one (two times in the present embodiment), and a block area which meets both the minimum number of times of recording and the free area is searched again from the inner periphery side of the disk. Incidentally, when an area which meets the minimum number of times of recording of 2 cannot be detected, then the number of times of recording of the area to be searched is increased by one, and thereafter the minimum number of times of recording is similarly increased one by one.

(2) Method for Recording Data to Disk

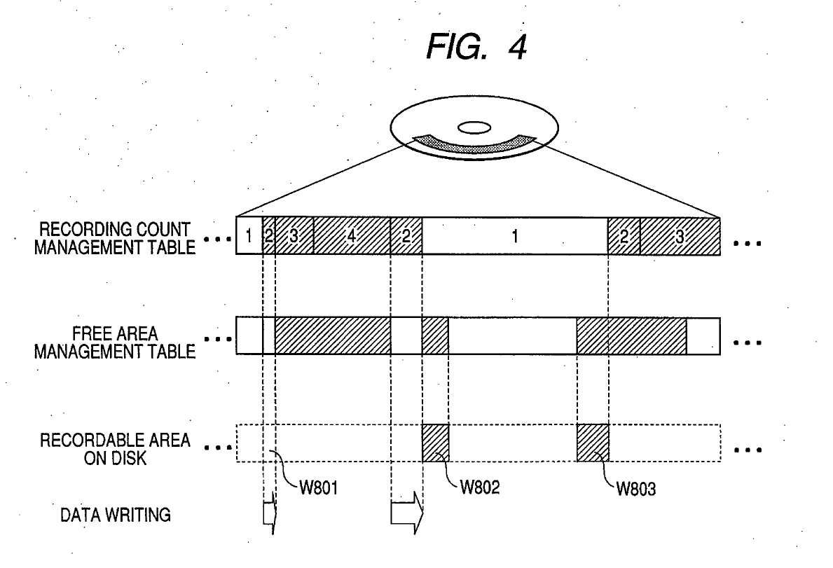

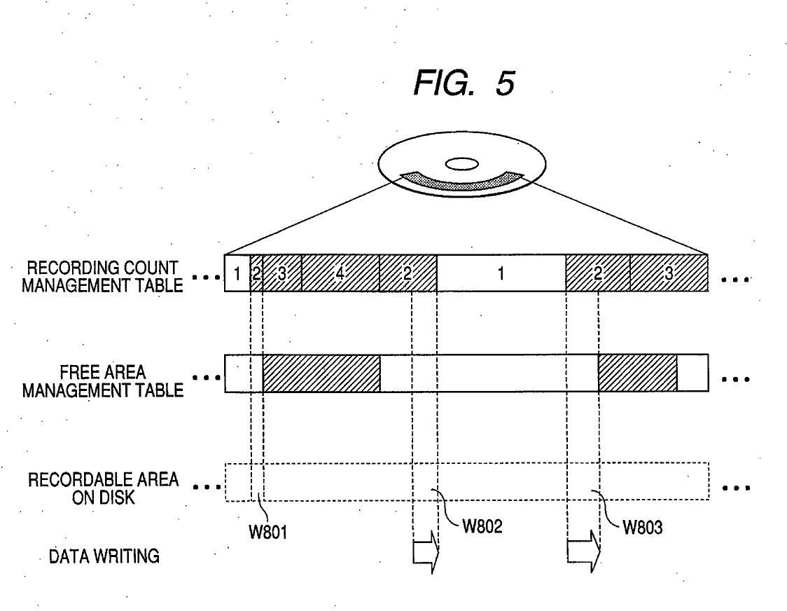

Next, a process of actually writing data to a disk based on the information about the recordable area acquired in the above-described procedure is explained below with reference to FIGS. 4 and 5.

When data writing is performed to the areas W801, W802, and W803 based on the result of acquiring the recordable area explained with reference to FIG. 3, the CPU 1 controls the respective units to perform data writing in the sequence from the inner periphery side recordable area S801 to the outer periphery side recordable area. FIG. 4 shows the information about the recording count management table and the free area management table and the data structure on the disk immediately after recording has been performed to the entirety of the area W801 shown in FIG. 3 and a part of the area W802 shown in FIG. 3.

As shown in FIG. 4, the number of times of recording in the recording count management table corresponding to the block and sector to which recording/writing has been performed above is increased by 1 to be updated to 2, and the corresponding area of the free area management table is updated to a recorded bit (1 in the present embodiment).

FIG. 5 shows the information about the recording count management table and the free area management table and the data structure on the disk immediately after data writing has been further performed. Similarly to the case shown in FIG. 4, data writing is performed to the entirety of the remaining portion of the area W802 shown in FIG. 3 and then to the entirety of the area W803 shown in FIG. 3; the number of times of recording in the recording count management table corresponding to the written area is updated to 2; and the corresponding area of the free area management table is updated to a recorded bit (1 in the present embodiment).

(3) Further Search and Reacquisition of Recordable Area

As described above, in response to a recording start instruction by a user, the series of data writing operation as shown in FIGS. 3 through 5 is performed. All the recordable areas on the disk have been used in the state shown in FIG. 5. However, in general, data recording must be further conducted unless the user issues a recording stop instruction. Otherwise, there may be adopted a method in which the user is give advance notice that the remaining recordable area of the disk is small to thereby avoid the above-mentioned situation, or a method of automatically stop the recording.

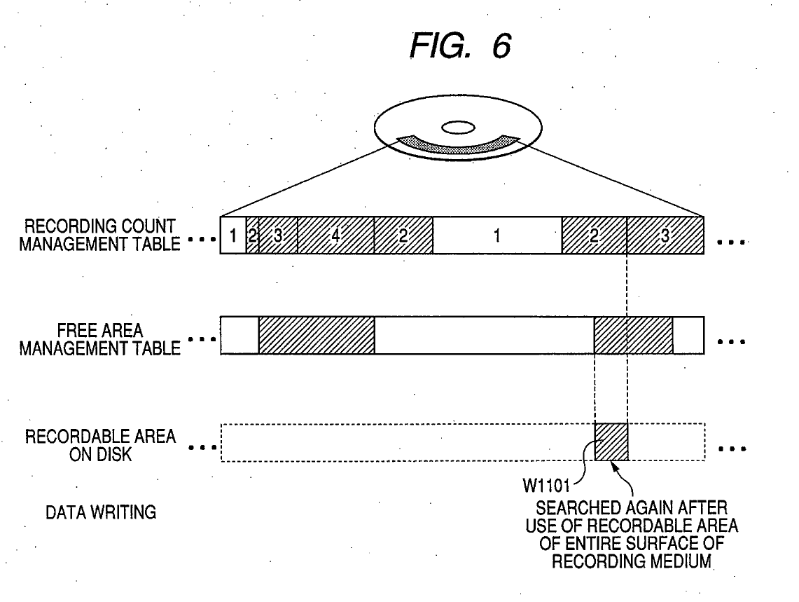

In the present embodiment, as shown in FIG. 6, unless the user issues a recording stop instruction, the latest recording count management table and free area management table will be searched again over the entire surface of the disk to acquire a recordable area (corresponding to W1101 shown in FIG. 6), and recording/writing is further conducted to that area.

(4) Process When Data is Deleted

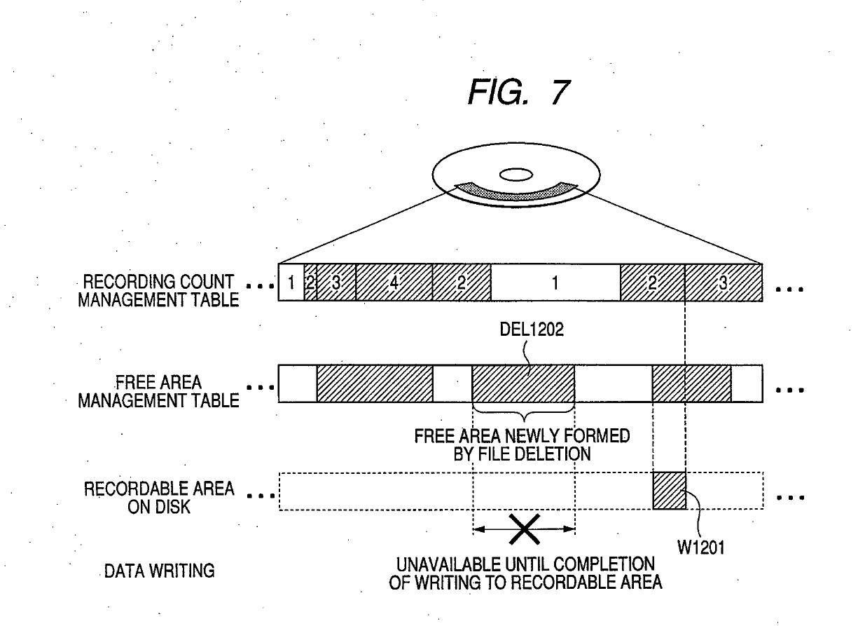

Further, when performing recording/writing to the disk, while the further data writing to the recordable area is performed, the user may perform an editing operation such as data deletion. FIG. 7 shows the information of the recording count management table and the free area management table and the data structure on the disk when a user issues a data deletion instruction in a state in which the entirety of the recordable areas acquired from the two management tables is not completely used yet (the state in which W1201 remains).

In the present embodiment, when data deletion is performed, it is sufficient that the sector area (DEL 1202) on the free area management table corresponding to the deleted data be updated to the unrecorded bit of 0.

By setting this area as unrecorded, an area which meets both this area and the area having the minimum number of times of recording of the recording count management table can be acquired. However, reacquisition is not performed until the entirety of the recordable area acquired by the last research is completely used, so that the deletion area DEL 1202 is disabled for data writing.

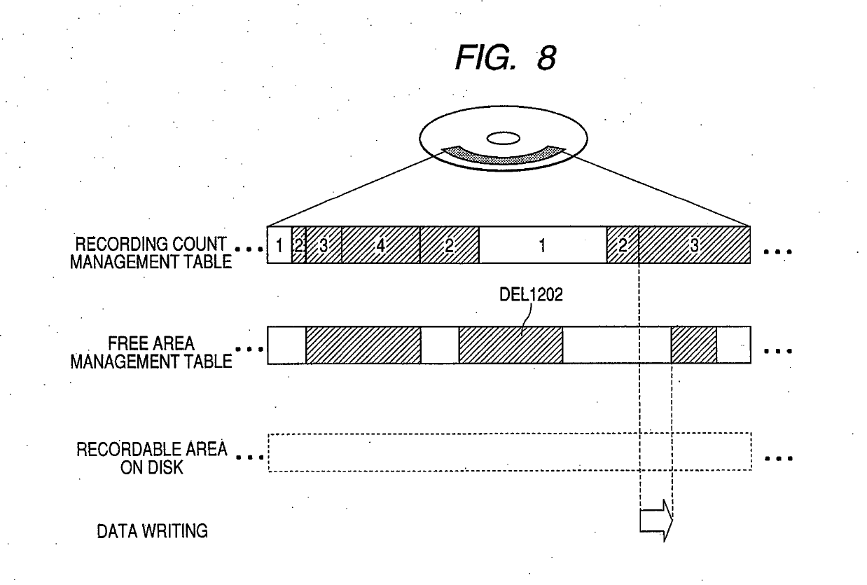

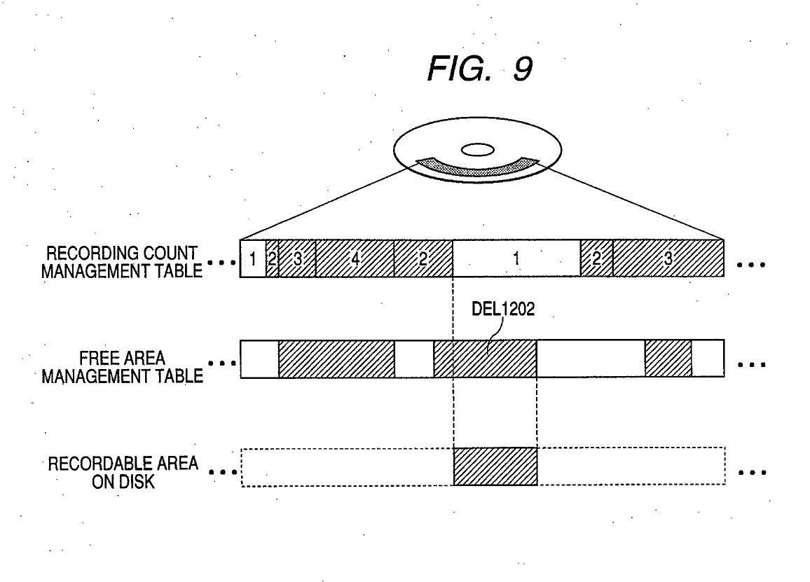

Therefore, only after data writing to the recording area corresponding to W1201 and update of both the recording count management table and the free area management table are completed as shown in FIG. 8, the research of a recordable area based on the recording count management table and the free area management table can be carried out again. Then, as shown in FIG. 9, a data area corresponding to the deletion area DEL 1202 can first be acquired as a recordable area at this point of time.

(5) Access Prohibition Control by Maximum Permitted Number of Times of Recording (Writing)

When data writing is carried out in plural times in a concentrated manner to the same area on a disk, physical degradation with time of the disk will increase the probability of generation of a write error or read error.

The upper limit of allowed number of times of data writing by overwriting will vary depending on the characteristics of a disk medium used. In the present embodiment, the value of a maximum permitted number of times of writing can be registered in the recording count management table of the disk as shown in FIG. 2.

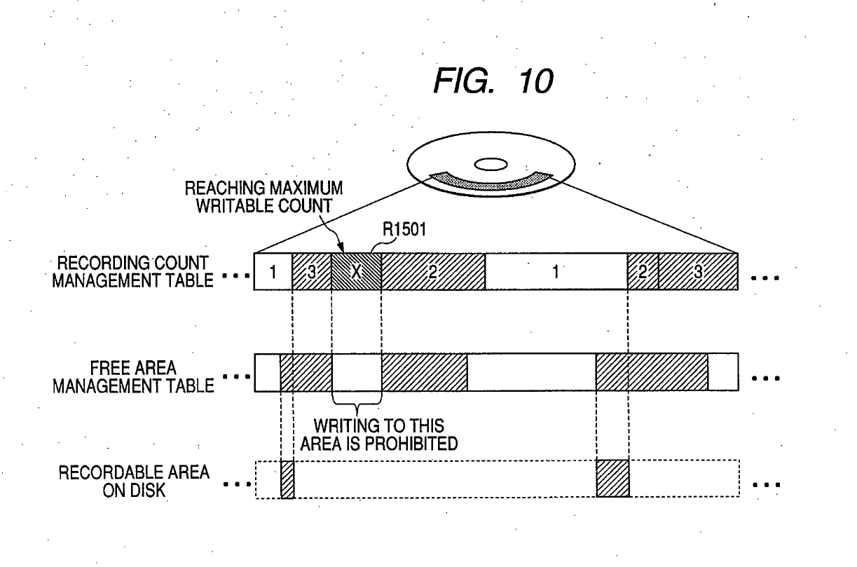

In the above-described procedure, the acquisition of a recordable area on the basis of the two management tables, the data writing to the recordable area, and the update of the two management tables are repeatedly carried out. As a result, when the maximum permitted number of times of recording (abbreviated as “maximum writable count” in the figure; 5 times in the present embodiment) is reached in a region R1501 as shown in FIG. 10, the CPU 1 sets a sector area of the free area management table corresponding to the area R1501 to be a recorded area and inaccessible.

(6) Update of Recording Count Management Table by Monitoring Update Date/Time

As shown in FIG. 2, the recording count management table has an update date/time information and also has a function such that when the recording date/time of a file on a disk is later than the update date/time, the number of times of recording of data in the recording count management table corresponding to the area of the disk in which the file is recorded is updated.

The function has such a meaning that when data writing to a disk is newly performed by a recording apparatus that has no recording count management table according to the present invention or cannot recognize a management information and then the disk is inserted into the recording apparatus having a management table according to the present invention, the inconsistency between the recording count management table and the free area management table is assessed and solved.

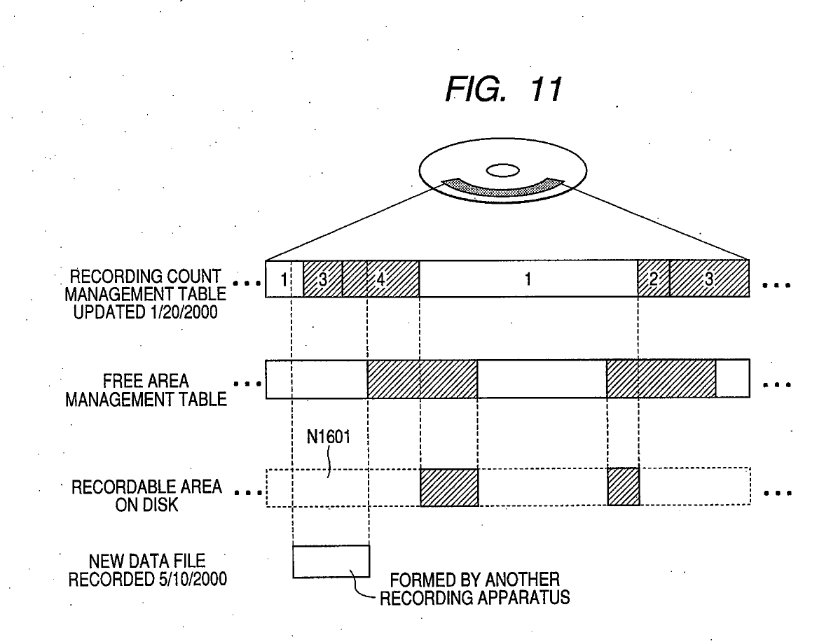

FIG. 11 shows two management information tables and data structure on a disk after data writing to an area of N1601 in a recording apparatus having no recording count management table, and then the disk is inserted into a recording apparatus having a recording count management table.

Generally, a data area recorded in a disk is managed as a data file, and has a generation date/time (recording date/time) information as to when the file was generated.

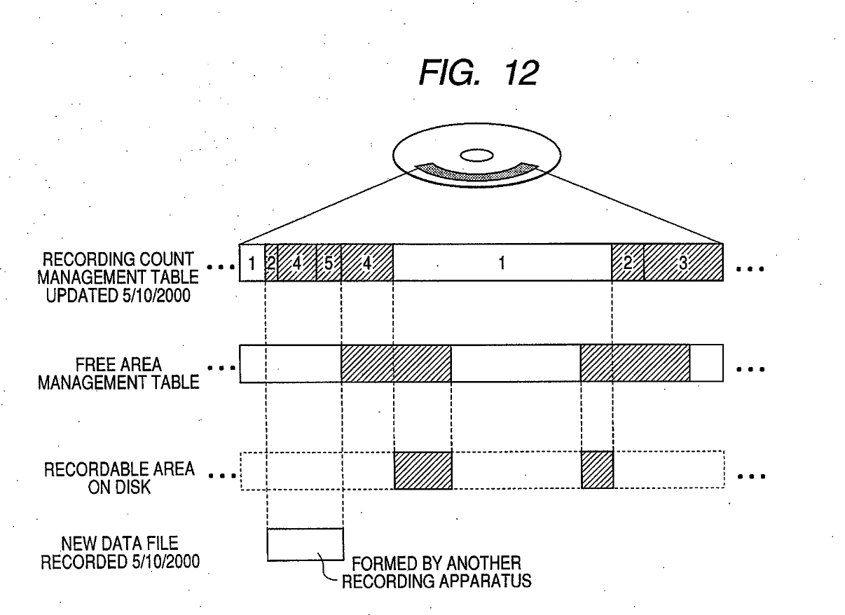

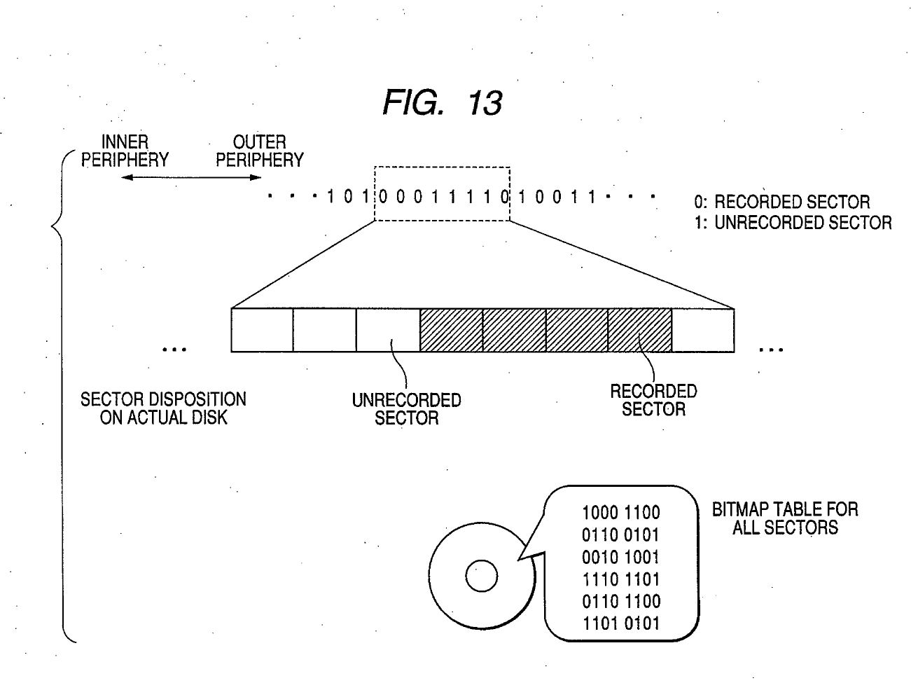

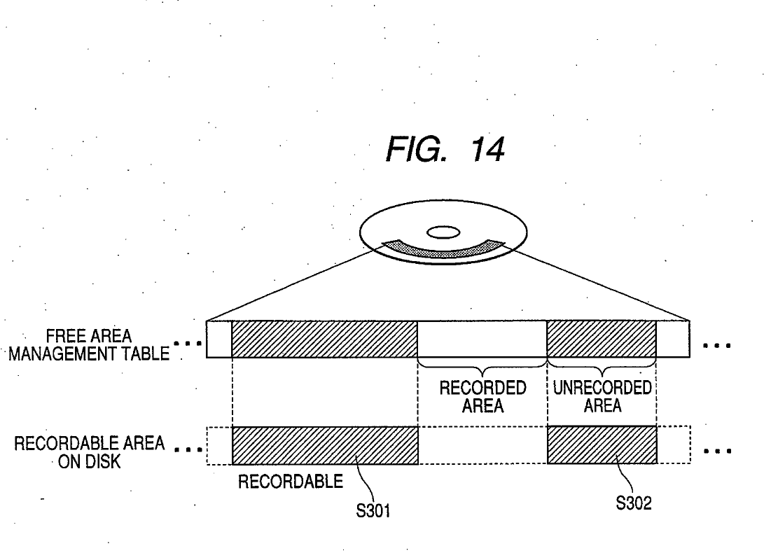

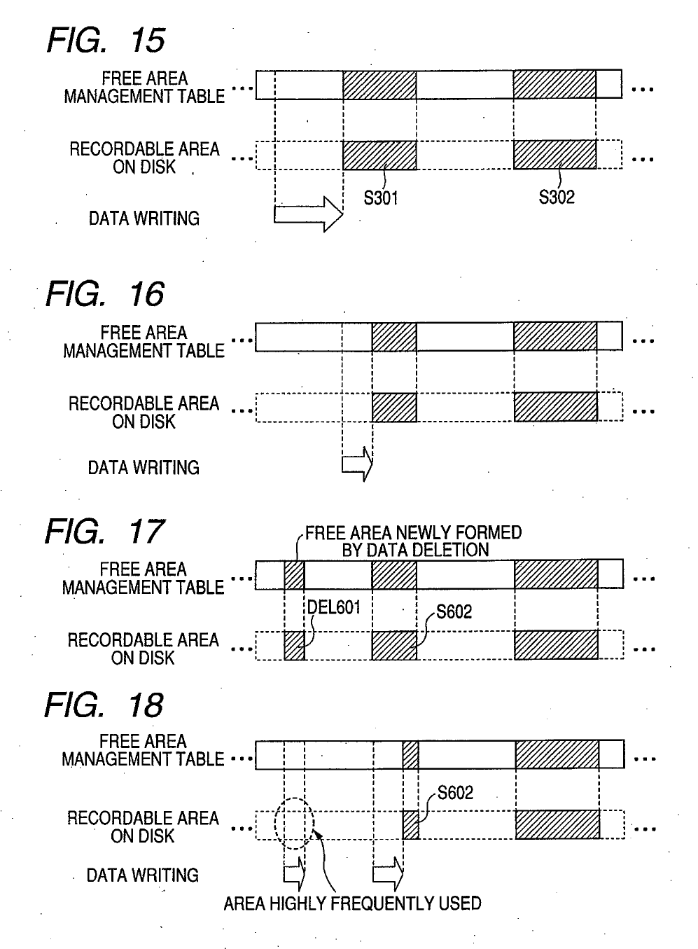

In the present embodiment, the generation date/time of each file and the latest update date/time of the recording count management table are compared with each other, and when the latest update date/time of the management information data is prior to the file generation date/time, then the data writing of the file is recognized to be carried out in another recording apparatus, and the recording count management table corresponding to the data area on the disk used by the file is updated (FIG. 12).

In FIG. 12, the values of numbers of times of recording in the recording count management table area corresponding to N1601 are increased by 1, respectively, and the latest update date/time of the recording count management table is updated to May 10, 2000 which is the same as the generation date/time of the file.

Although in the present embodiment, the update is performed based on the date only, but the time information can be registered in the management table, so that the date can be managed with higher precision in a second unit for even date.

This application claims priority from Japanese Patent Application No. 2005-048994 filed Feb. 24, 2005, which is hereby incorporated by reference herein.

What is claimed is:

1. An information recording apparatus in which a recording area of an information recording medium is managed in block units of a predetermined size, comprising:
a memory for storing an information to numbers of times of recording of respective blocks and an information to a free area of the respective blocks; and
a circuit for determining a block for recording an information therein based on the both informations stored in the memory.

2. The apparatus according to claim 1, wherein after the information recording to the information recording medium, the information to numbers of times of recording and the information to a free area are updated.

3. The apparatus according to claim 1, wherein the predetermined size is an ECC block size.

4. The apparatus according to claim 1, wherein the information to numbers of times of recording is stored in a form of a table, and the table is sorted in an order of number of times of recording.

5. The apparatus according to claim 4, wherein the circuit for determination searches the table and determines a block of a smaller number of times of recording preferentially as a block in which the information is recorded.

6. The apparatus according to claim 4, wherein the table of the information to numbers of times of recording has an information to update date/time, and when a recording date/time of a file on the information recording medium is later than the update date/time, the number of times of recording of a block corresponding to the area in which the file is recorded is updated.

7. The apparatus according to claim 4, wherein the circuit for determination can set a maximum permitted number of times of recording, and when number of times of recording to the information recording medium reaches the maximum permitted number of times of recording, a corresponding area is set to prohibit recording.
